(19) United States
(12) Patent Application Publication
(10) Pub. No.: US 2006/0182131 A1
(43) Pub. Date: Aug. 17, 2006

(54) Gateway interface control

(75) Inventor: Richard R. Dziekan JR., North Wales, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: L-3 Communications Corporation, New York, NY (US)

(21) Appl. No.: 11/334,656

(22) Filed: Jan. 18, 2006

Related U.S. Application Data
(60) Provisional application No. 60/645,775, filed on Jan. 21, 2005.

(51) Int. Cl. H04L 12/56; H04L 12/28

(52) U.S. Cl. 370/401

(57) ABSTRACT

An IP/ISDN/PSTN gateway provides an IP secure telephone with the capability of interfacing to either an ISDN-configured SCIP secure telephone or a PSTN-configured SCIP secure telephone. A translation function is performed between multiple protocols that allows IP secure telephones to communicate with SCIP secure telephones on ISDN and/or PSTN network(s). The gateway, in conjunction with a call manager, establishes a connection that accommodates the flow of voice and/or data traffic between an IP secure telephone and an SCIP secure telephone. One or more call managers on the IP network arrange and maintain call connectivity between an IP secure telephone and the “IP” side of the gateway. The “ISDN/PSTN” side of the gateway, in turn, provides an interface to support the flow of voice and/or data traffic to/from an SCIP secure telephone located on an ISDN or PSTN network.

### CROSS-REFERENCE TO RELATED APPLICATIONS

This application claims the benefit of U.S. provisional patent application Ser. No. 60/645,775, filed Jan. 21, 2005, herein incorporated by reference in its entirety.

### BACKGROUND

Secure Communication Interoperability Protocol (“SCIP”, formerly called Future Narrow Band Digital Terminal “FNBDT”) signaling defines a protocol by which two devices transition from a non-secure call state to a secure call state and from a secure call state back to a non-secure call state. Public switched telephone network (“PSTN”) devices typically use a modem to carry the encrypted data when in a secure call state. Wireless and other digital devices on digital networks typically send encrypted voice and data digitally on their home networks.

Where interfacing is required between digital (e.g., wireless) and PSTN (e.g., modem-based) secure devices, a network element called an interworking function (“IWF”) is employed. This device acts as a bridge between two different network types, typically with a modem on the PSTN side of the IWF and a digital output on the digital side.

It is desirable to provide an IWF for internet protocol (“IP”) secure telephones. It is further desirable to provide messaging to support an external gateway interface that allows non-secure and secure communications between a classic (e.g., SCIP enabled) secure telephone and an IP (e.g., digital) secure telephone.

Moreover, in Voice over IP (“VoIP”) networks, traffic between VoIP endpoints and gateways normally uses real-time protocol (“RTP”). Commercial gateways typically do not support modem traffic from IP endpoints. Various techniques have been proposed and standardized for the passing of modem signals between gateways (known as modem pass-through or modem relay). It would be desirable to provide secure telephony in such systems.

### SUMMARY

In VoIP networks, an IP/ISDN (integrated services digital network)/PSTN gateway (henceforth also referred to as “the gateway”) provides a bridge between the VoIP network and a PSTN network. This provides VoIP devices with the capability of interfacing to legacy voice terminals on the PSTN.

For secure telephony, a gateway exists at the PSTN/IP interface with a modem on the PSTN side. A messaging protocol is established between IP secure telephones and such gateways. This enables the IP secure telephone to send secure traffic to a gateway, signaling the gateway to activate and use its modem if required to enable end-to-end communication across a hybrid IP/PSTN network. For secure telephony, the gateway acts as an IWF.

To provide IP secure telephone-gateway signaling/messaging, existing in-band protocols such as named signaling events (“NSEs”) are used and extended. NSEs are themselves extensions of the RTP protocol. For example, aspects may be based upon the ITU standard V.150.1. Additional aspects of the invention include messaging details and associated call flows and scenarios.

### BRIEF DESCRIPTION OF THE DRAWINGS

FIG. 1 is a diagram of an example gateway environment.

FIG. 2 is a diagram of an example gateway architecture.

FIG. 3 is a diagram of an example voice channel packet format.

FIG. 4 is a diagram of an example digital channel packet format utilizing voice channel packet size.

FIG. 5 is a diagram of an example digital channel packet format utilizing digital channel packet size.

FIG. 6 is a diagram of an example gateway state diagram.

FIG. 7 is a diagram of an example gateway/IP secure telephone NSE interface.

FIG. 8 is a diagram useful in describing example voice channel characteristics.

FIG. 9 is a diagram useful in describing an example IP secure telephone initiating voice channel restoration.

FIG. 10 is a diagram showing an example state transition of an IP secure telephone initiating voice channel restoration.

FIG. 11 is a diagram useful in describing an example SCIP secure telephone initiating voice channel restoration.

FIG. 12 is a diagram showing an example state transition of an SCIP secure telephone initiating voice channel restoration.

FIG. 13 is a diagram useful in describing example digital channel characteristics.

FIG. 14 is a diagram useful in describing an example gateway initiating digital channel establishment.

FIG. 15 is a diagram showing an example state transition of an example gateway initiating digital channel establishment.

FIG. 16 is a diagram useful in describing an example IP secure telephone initiating digital channel establishment.

FIG. 17 is a diagram showing an example state transition of an example IP secure telephone initiating digital channel establishment.

### DETAILED DESCRIPTION OF ILLUSTRATIVE EMBODIMENTS

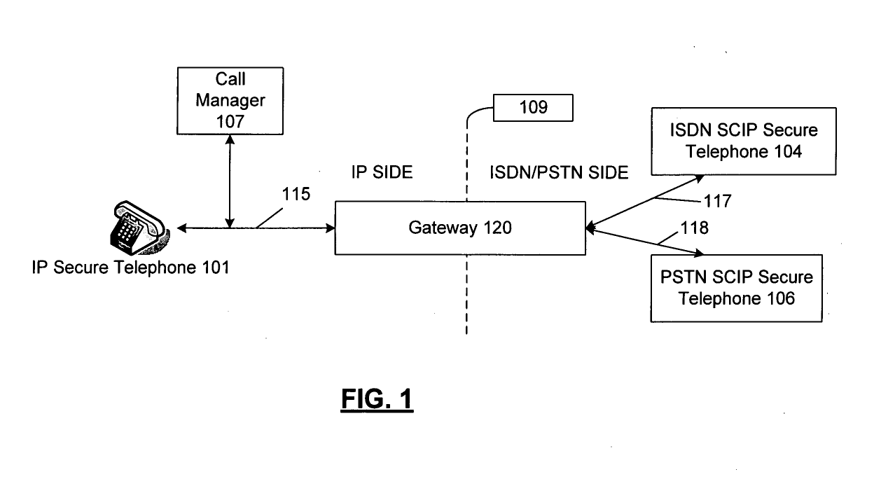

FIG. 1 is a diagram of an example gateway environment. An example IP/ISDN/PSTN gateway 120 provides an IP secure telephone 101 with the capability of interfacing to either an ISDN configured SCIP secure telephone 104 or a PSTN configured SCIP secure telephone 106. In either case, the messaging between the IP secure telephone 101 and the gateway 120 may be similar.

The example gateway 120 desirably performs a translation function between multiple protocols or data that allows one or more IP secure telephones 101 to communicate with one or more ISDN SCIP secure telephones 104 or PSTN SCIP secure telephones 106 via ISDN and/or PSTN network(s). The gateway 120, in conjunction with a call manager 107, desirably establishes a secure connection or channel that accommodates the flow of voice and/or data traffic between the IP secure telephone 101 and one of the SCIP secure telephones 104 and 106. A secure channel between IP secure telephone 101 and the gateway 120 is illustrated at 115. Similarly, example secure channels between the gateway 120, and ISDN SCIP secure telephone 104 and PSTN secure telephone 106, are illustrated at 117 and 118, respectively.

One or more call managers 107 on the IP network arrange and maintain call connectivity between the IP secure telephone 101 and the “IP” side of the gateway. The call manager 107 may include a network device which acts as an endpoint address translation agent, proxy server, or acts to support the translation or interoperability of VoIP protocols, for example.

The “ISDN/PSTN” side of the gateway 120, in turn, provides an interface to support the flow of voice and/or data traffic to/from one of the ISDN SCIP secure telephone 104 and PSTN SCIP secure telephone 106 located one of the ISDN or PSTN networks. The “IP” side and the “ISDN/PSTN” side of the gateway 120 are delineated on FIG. 1 by dotted line 109.

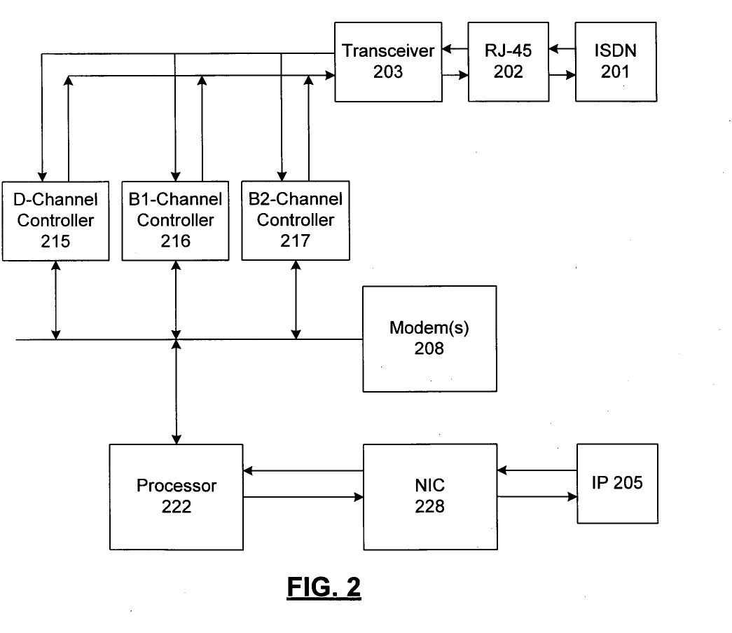

FIG. 2 is a diagram of an example gateway architecture. The gateway architecture may be part of the gateway 120 illustrated in FIG. 1. An example gateway contains an interface between an IP network 205 and an ISDN network 201. The gateway may additionally contain one or more commercial off-the-shelf (“COTS”) modems 208 for connection to a PSTN network (not shown), for example.

As illustrated, traffic from the ISDN network 201 may pass through interface RJ-45 202 and into transceiver 203. The D, B1, and B2 channels of the ISDN connection may be separated and passed by the transceiver 203 to a corresponding controller 215, 216, or 217. Controllers 215-217 may process their respective signals according to the Q.931 protocol for ISDN connection control, for example; however, any protocol known in the art for ISDN connection control may be used.

The controllers 215-217 may be further connected to one or more modems 208, and a processor 222 via a bus or other connector. To facilitate connection to a PSTN SCIP secure telephone, the channel controllers 215-217 may output via the bus to one or more modems 208. The modems 208 may process the received signal according to one or more ITU-TS modem protocols, including V.90, V.34, and V.32, for example; however, any modem protocol may be used.

To facilitate connection to an IP secure telephone, the channel controllers 215-217 may output to a processor 222 via the bus. The processor 222 may convert the received voice data into a format suitable for distribution over the IP 205 network. For example, the processor 222 may apply the G.711 protocol for encoding telephone audio. However, any known audio encoding protocol may be used. Similarly, the processor 222 may convert received data from the IP 205 network into a format suitable for distribution over the PSTN or ISDN network 201.

Once in a suitable format, the voice data may be further processed for transmission across the IP network 205. The processor 222 is desirably connected to the IP network 205 through one or more network interface cards (“NIC”) 228. Non-secure voice may be sent using standard G.711 or G.229A digital coding, for example. Secure voice data may be transmitted according to the SCIP/FNBDT-210 specification. Either data stream may be broken into packets and transmitted over the IP network within UDP packets as defined by the Real Time Protocol (RTP, RFC 3550). However any system, method, or technique for transmitting packets across a network may be used.

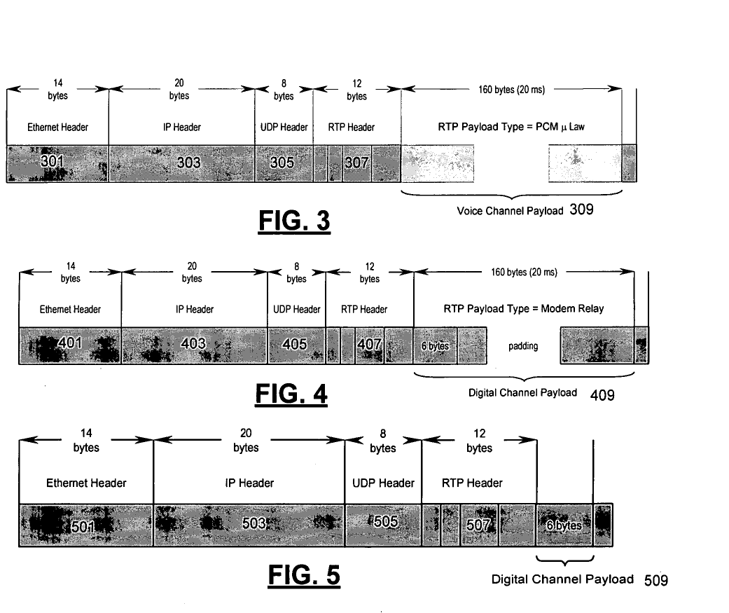

As described above, packets may be transferred between an IP secure telephone and the “IP” side of the gateway over UDP via RTP packets, for example. FIG. 3 is a diagram of an example voice channel packet format, FIG. 4 is a diagram of an example digital channel packet format utilizing voice channel packet size, and FIG. 5 is a diagram of an example digital channel packet format utilizing digital channel packet size. The optimal packet payload size may be determined by network bandwidth limits, latency goals, or a combination of both constraints, for example.

The voice channel packet may include an Ethernet header 301, an IP header 303, a UDP Header 305, and an RTP Header 307. These portions of the voice channel packet may be used for routing purposes, for example. In addition, the voice channel packet may include a voice channel payload 309.

The digital channel packet utilizing voice channel packet size may include an Ethernet header 401, an IP header 403, a UDP Header 405, and an RTP Header 407. In addition, the digital channel packet may include a digital channel payload 409.

The digital channel packet utilizing digital channel packet size may include an Ethernet header 501, an IP header 503, a UDP Header 505, and an RTP Header 507. In addition, the digital channel packet may include a digital channel payload 509.

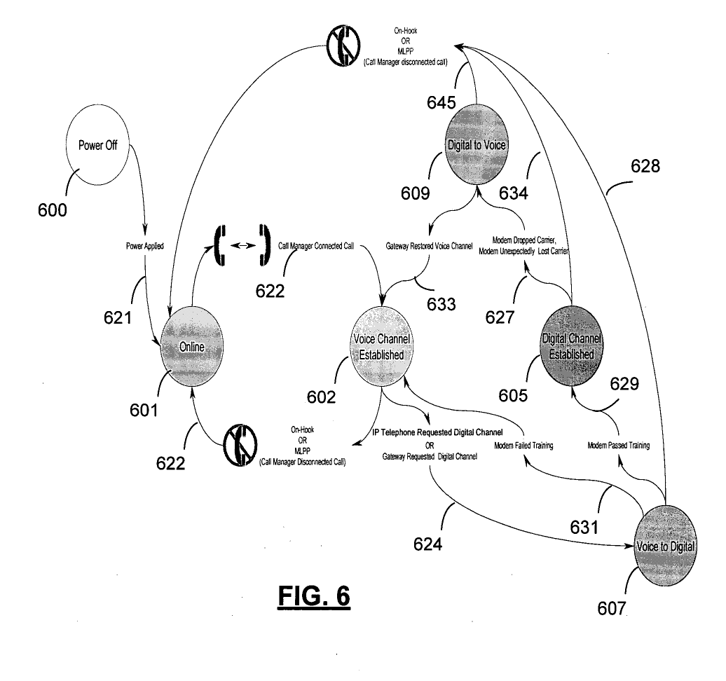

An example gateway controller may include several gateway voice channels and digital channels. Each gateway channel may operate according to an associated gateway state transition diagram. FIG. 6 is an illustration of an example gateway transition diagram.

The gateway desirably resides in a primary operational state, such as: (1) an online state 601, (2) a voice channel established state 602, and (3) a digital channel established state 605, for example. Additionally, the gateway may reside in an intermediate state, such as: (1) a voice to digital transition state 607 and (2) a digital to voice transition state 609, for example. With the exception of the power off 600 and online state 601, state transitions are desirably determined by the outcomes of various NSE message exchange sequences.

The gateway desirably enters the online state 601 after (1) the user has applied power to the unit (transition 621), (2) the call manager has informed the gateway of an “on-hook” action at either endpoint (transition 645 or 622), or (3) a Multi-Level Preemption and Precedence (“MLPP”) event has terminated a call (transition 645). The online state 601 may be characterized by an indeterminate period of call inactivity. The gateway is desirably available for calls for as long as it remains in the online state 601.

The gateway may transition from the online state 601 to the voice channel established state 602 after the call manager has established call connectivity between the IP secure telephone and the gateway. More particularly, the gateway desirably transitions to the voice channel established state 602 when (1) the call manager has completed call setup between an IP secure telephone and the gateway (transition 622), (2) the gateway modem has (unexpectedly) lost its carrier (transitions 627, 633), (3) the gateway modem has (expectedly) dropped its carrier (transitions 627, 633), or (4) the gateway modem has failed modem training (transition 631).

The gateway desirably forwards traffic packets across the voice channel for as long as it resides in the voice channel established state 602. The gateway may also forward an incoming bit stream from the SCIP secure telephone to the gateway modem for extended system configuration data (“ESCD”) detection. Moreover, the gateway desirably monitors its NSE interface with the IP secure telephone for incoming messages. If the gateway has previously transitioned from the digital to voice state 609, the IP secure telephone may direct it to change the traffic packet size of the newly restored voice channel to the voice channel packet size through a NSE message exchange.

The gateway desirably exits the voice channel established state 602 after (1) the gateway has acknowledged a request for a digital channel by the IP secure telephone (transition 624), (2) the IP secure telephone has acknowledged a request for a digital channel by the gateway (transition 624), (3) the call manager has informed the gateway of an “on-hook” action at either endpoint (transition 602), or (4) an MLPP event has terminated a call (transition 602). These exit conditions and their resultant states may be partially determined by the outcomes of NSE message exchange sequences with the IP secure telephone, for example.

The gateway transitions to the digital channel established state 605 when the gateway modem has successfully completed modem training with an SCIP secure telephone (transition 629).

Upon entering the digital channel established state 605, the gateway desirably forwards traffic packets across the newly established digital channel and continues to size the traffic packets in accordance with the voice channel packet size. The IP secure telephone may direct the gateway to change the traffic packet size of the digital channel to the digital channel packet size through a NSE message exchange. The gateway also desirably monitors its NSE interface with the IP secure telephone for other incoming messages. Moreover, the gateway modem periodically reports status to the gateway.

The gateway desirably exits the digital channel established state 605 after (1) the gateway modem has gracefully dropped its carrier (transition 627), (2) the gateway modem has unexpectedly lost its carrier (transition 627), (3) the call manager has informed the gateway of an “on-hook” action at either endpoint (transition 634), or (4) an MLPP event has terminated a call (transition 634). These exit conditions and their resultant states may be partially dependent upon the outcomes of NSE message exchanges between the IP secure telephone and the gateway.

As described previously, the voice to digital transition state 607 is an intermediate gateway state. The gateway transitions to the voice to digital transition state 607 when (1) the gateway has acknowledged a request for a digital channel by the IP secure telephone (transition 624), or (2) the IP secure telephone has acknowledged a request for a digital channel by the gateway (transition 624). The gateway desirably attempts to establish a digital channel during the voice to digital transition state 607 when its modem engages in modem training with the modem in the SCIP secure telephone. Both the IP secure telephone and the SCIP secure telephone are capable of initiating a modem training session between the gateway modem and the SCIP secure telephone.

The gateway desirably exits the voice to digital transition state 607 after (1) the gateway modem has passed modem training with the SCIP secure telephone (transition 629), (2) the gateway modem has failed modem training with the SCIP secure telephone (transition 631), (3) the call manager has informed the gateway of an “on-hook” action at either endpoint (transition 628), or (4) an MLPP event has terminated a call (transition 628). These exit conditions and their resultant states are desirably partially dependent upon the outcomes of NSE message exchanges between the IP secure telephone and the gateway.

The digital to voice transition state 609 is another intermediate gateway state. The gateway moves to the digital to voice transition state 609 when (1) the gateway modem has gracefully dropped its carrier (transition 627) or (2) the gateway modem has unexpectedly lost its carrier (transition 627). The gateway desirably deconstructs the digital channel and restores the voice channel during the digital to voice transition state 609.

The gateway desirably exits the digital to voice transition state 609 after (1) the IP secure telephone has acknowledged that the gateway has successfully restored the gateway channel characteristics to that of a voice channel (transition 633), (2) the call manager has informed the gateway of an “on-hook” action at either endpoint (transition 645), or (3) an MLPP event has terminated a call (transition 645). These exit conditions and their resultant states may be partially dependent upon the outcomes of NSE message exchanges between the IP secure telephone and the gateway.

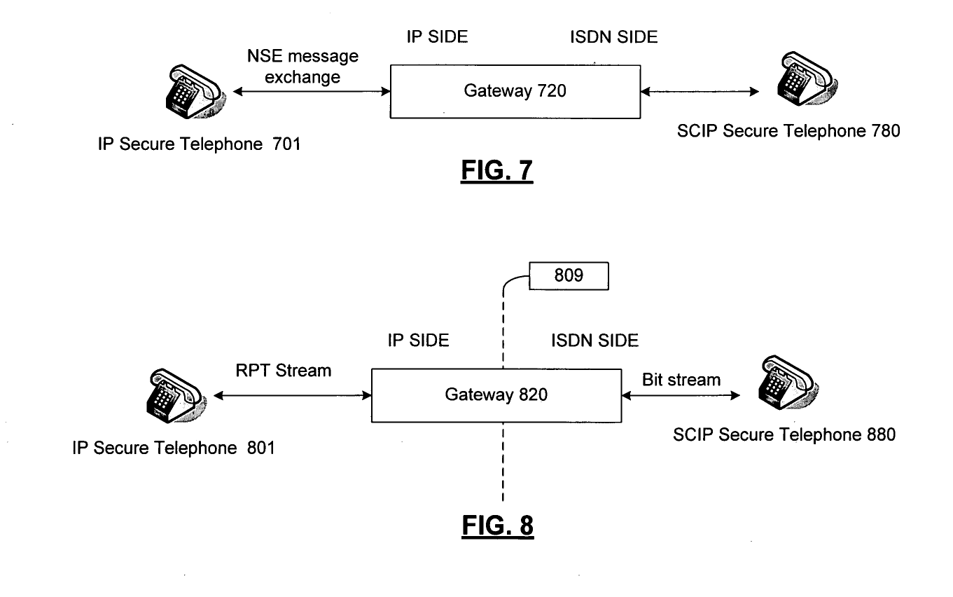

FIG. 7 is a diagram of an example gateway/IP secure telephone NSE interface. The IP secure telephone 701 utilizes NSEs to send commands to the “IP” side of the gateway 720. The commands may be used to establish a voice or digital channel between the IP secure telephone 701 and the SCIP secure telephone 780. As described previously, NSEs or named signaling events, are existing in-band protocols. Likewise, the IP secure telephone 701 receives status and request messages from the “IP” side of the gateway 720 in the form of NSEs. The gateway 720 may not send or receive NSEs when it is in the online state. NSEs are an extension of the existing RTP protocol and are transported within the RTP stream of a digital channel or a voice channel. A single NSE may contain one or more messages, for example.

FIG. 8 is a diagram useful in describing example voice channel characteristics. Moreover, FIG. 8 shows a non-secure voice channel over a hybrid IP/ISDN path. The gateway 820 enables communications between an IP secure telephone 801 and an SCIP secure telephone 880 by orchestrating the establishment and/or tear down of voice channels and digital channels. An IP secure telephone 801 and an SCIP secure telephone 880 form the respective endpoints of both voice channels and digital channels.

A voice channel exists as a bi-directional RTP stream between an IP secure telephone 801 and the IP side of the gateway 820. The division of the gateway 820 into the IP side and the ISDN side is illustrated by dotted line 809. The remainder of a voice channel desirably takes the form of a processed bi-directional serial bit stream between the ISDN side of the gateway and the SCIP secure telephone 880. The ISDN side of the gateway 820 also desirably includes a modem detection function. Incoming data traverses the modem detection function upon entering the ISDN side of the gateway 820. The modem detection function allows the gateway 820 to continuously monitor or “sniff” incoming data for the ESCD waveform. A voice channel is desirably active for the duration of the voice channel established state.

By default, the gateway 820 may establish a voice channel shortly after the call manager completes call setup. A successful call setup sequence (moderated by a call manager) desirably results in the creation of a bi-directional RTP stream between the IP secure telephone 801 and the gateway 820, and a processed serial bit stream between the gateway 820 and the SCIP secure telephone 880. The serial bit stream is desirably generated according to the particular codec utilized. Any suitable codec for use in audio applications may be used.

Both the SCIP secure telephone 880 and the IP secure telephone 801 are capable of initiating the restoration of a voice channel. The SCIP secure telephone 880 and IP secure telephone 801 use different mechanisms to restore a voice channel. As shown in FIG. 6, for example, the gateway 820 operates in the digital to voice transition state while the endpoints attempt to re-establish a voice channel.

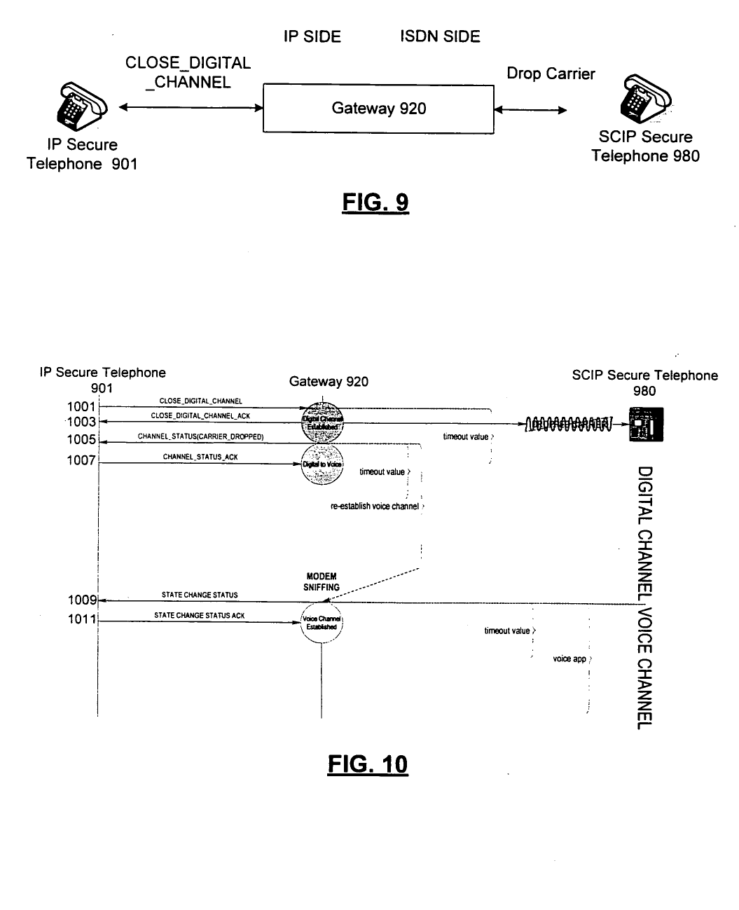

FIG. 9 is a diagram useful in describing an example IP secure telephone 901 initiating voice channel restoration. FIG. 10 is a diagram showing an example state transition of the IP secure telephone 901 initiating voice channel restoration. The IP secure telephone 901 desirably initiates voice channel restoration with the SCIP secure telephone 980 when it begins the graceful shutdown of the digital channel application. Upon termination of the digital channel application, the IP secure telephone 901 sends a CLOSE_DIGITAL_CHANNEL message to the gateway 920 at 1001. The gateway 920 desirably acknowledges receipt of the CLOSE_DIGITAL_CHANNEL message and commands the gateway 920 modem to drop its carrier causing the gateway 920 to enter the digital to voice transition state at 1003. The gateway 920 desirably sends a CHANNEL_STATUS message to the IP secure telephone 901 indicating that the gateway 920 modem has dropped its carrier at 1005.

The gateway 920 may spend the remainder of its time in the digital to voice transition state restoring the voice channel traffic path and placing the gateway 920 modem in the ESCD detection or “sniffing” mode at 1007. The gateway 920 desirably sends the STATE_CHANGE_STATUS message to the IP secure telephone 901 indicating that it has successfully transitioned to the voice channel established state and is ready for packet traffic at 1009. The IP secure telephone 901 may then acknowledge receipt of the STATE_CHANGE_STATUS message at 1011.

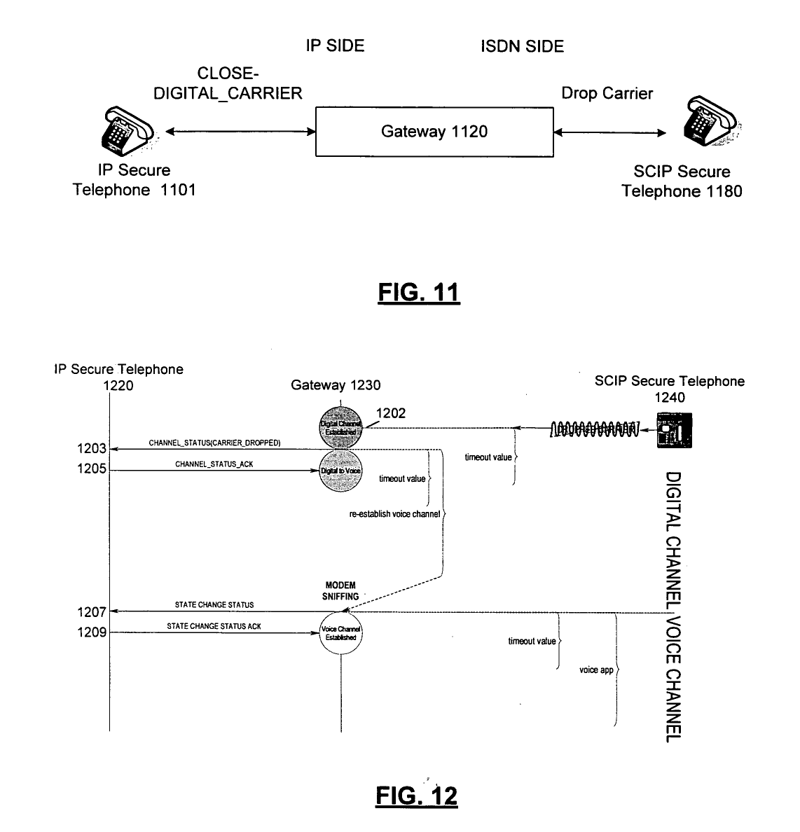

FIG. 11 is a diagram useful in describing an example SCIP secure telephone 1180 initiating voice channel restoration. FIG. 12 is a diagram showing an example state transition of the SCIP secure telephone 1180 initiating voice channel restoration. The SCIP secure telephone 1180 initiates voice channel restoration with the IP secure telephone 1101 when it begins the graceful shutdown of the digital channel application. Upon termination of the digital channel application, the SCIP secure telephone 1180 drops its carrier at 1202. The gateway 1120 may then enter the digital to voice transition state and send the CHANNEL_STATUS message to the IP secure telephone 1101 indicating that the gateway modem has lost its carrier at 1203.

At 1205, the IP secure telephone 1101 desirably sends an acknowledgement message to the gateway 1120, and the gateway 1120 spends the remainder of its time in the digital to voice transition state restoring the voice channel traffic path and placing the gateway 1120 modem in the ESCD detection or “sniffing” mode. At 1207, the gateway 1120 desirably sends the STATE_CHANGE_STATUS message to the IP secure telephone 1101 indicating that it has successfully transitioned to the voice channel established state and is ready for packet traffic. Moreover, at 1209, the IP secure telephone 1101 desirably sends an acknowledgment message to the gateway 1120.

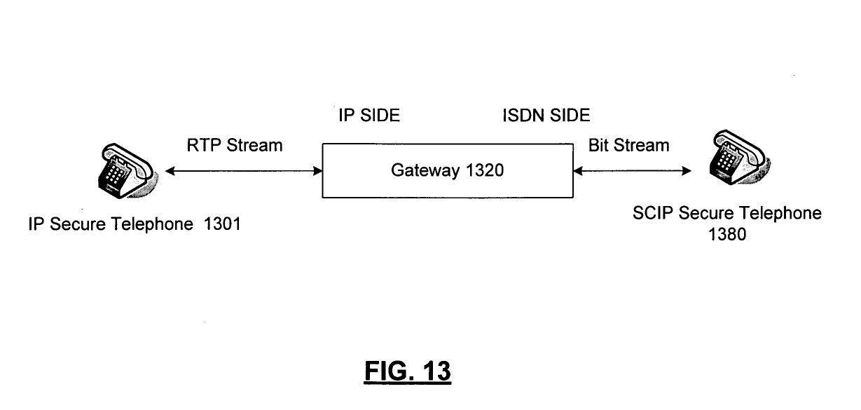

FIG. 13 is a diagram useful in describing example digital channel characteristics. FIG. 13 shows a secure digital voice channel over a hybrid IP/PSTN path. A digital channel is similar to a voice channel in that it exists as a bi-directional RTP stream between an IP secure telephone 1301 and the IP side of the gateway 1320. The remainder of a digital channel, however, takes the form of a bi-directional serial bit stream that passes through the gateway modem as it traverses the ISDN side of the gateway on its way to and from an SCIP secure telephone 1380.

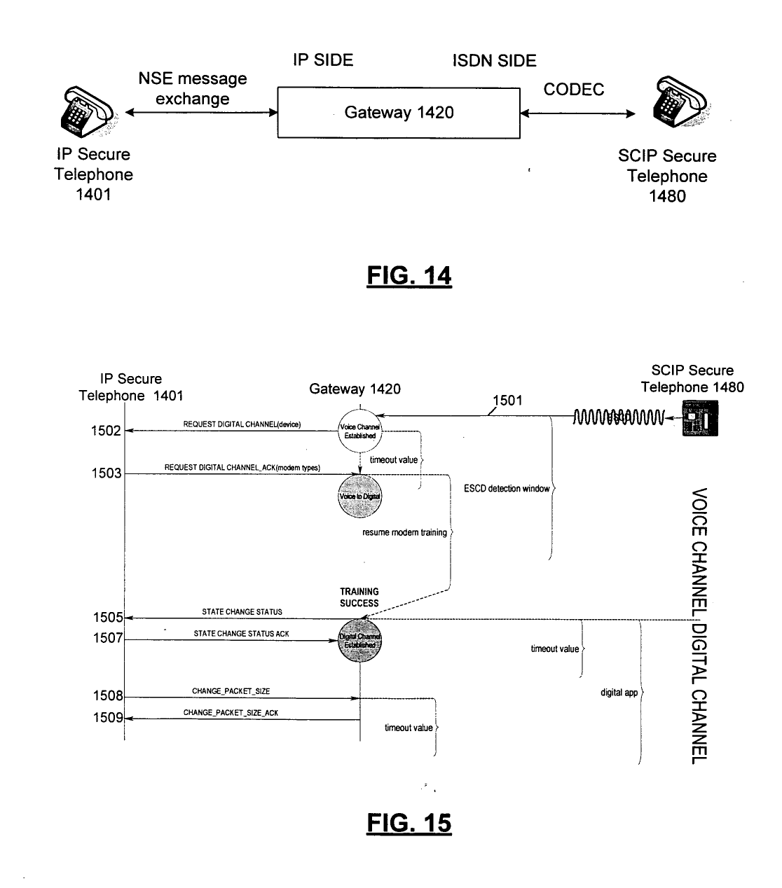

FIG. 14 is a diagram useful in describing an example gateway initiating digital channel establishment, and FIG. 15 is a diagram showing an example state transition of an example gateway initiating digital channel establishment. AN SCIP secure telephone 1480 requests an end-to-end digital connection with an IP secure telephone 1401 when it sends the ESCD waveform and thereby initiates modem training with the facilitating gateway 1420 at 1501. The gateway 1420 desirably forwards this request for a fully digital connection by sending a REQUEST_DIGITAL_CHANNEL message to an IP secure telephone 1401 at 1502. The contents of this message desirably inform the IP secure telephone 1401 of the gateway 1420 capabilities (e.g., in the form of a capabilities list).

The IP secure telephone 1401 responds by sending a REQUEST_DIGITAL_CHANNEL_ACK message to the gateway 1420 at 1503. The REQUEST_DIGITAL_CHANNEL_ACK message may allow the IP secure telephone 1401 to select the appropriate gateway 1420 capability(s) to be used during the establishment of an end-to-end digital connection, for example. The gateway 1420 desirably transitions to the voice to digital state upon receiving the REQUEST_DIGITAL_CHANNEL_ACK message where it resumes modem training with the SCIP secure telephone 1480. The gateway 1420 desirably sends a STATE_CHANGE_STATUS message to the IP secure telephone 1401 upon completing modem training with the SCIP secure telephone 1480 at 1505. The STATE_CHANGE_STATUS message desirably allows the gateway 1420 to inform the IP secure telephone 1401 that it has successfully completed modem training with an SCIP secure telephone 1480 and that it has changed its operating state to digital channel established.

After receiving the STATE_CHANGE_STATUS message, the IP secure telephone 1401 desirably sends an acknowledgment message to the gateway 1420 at 1507

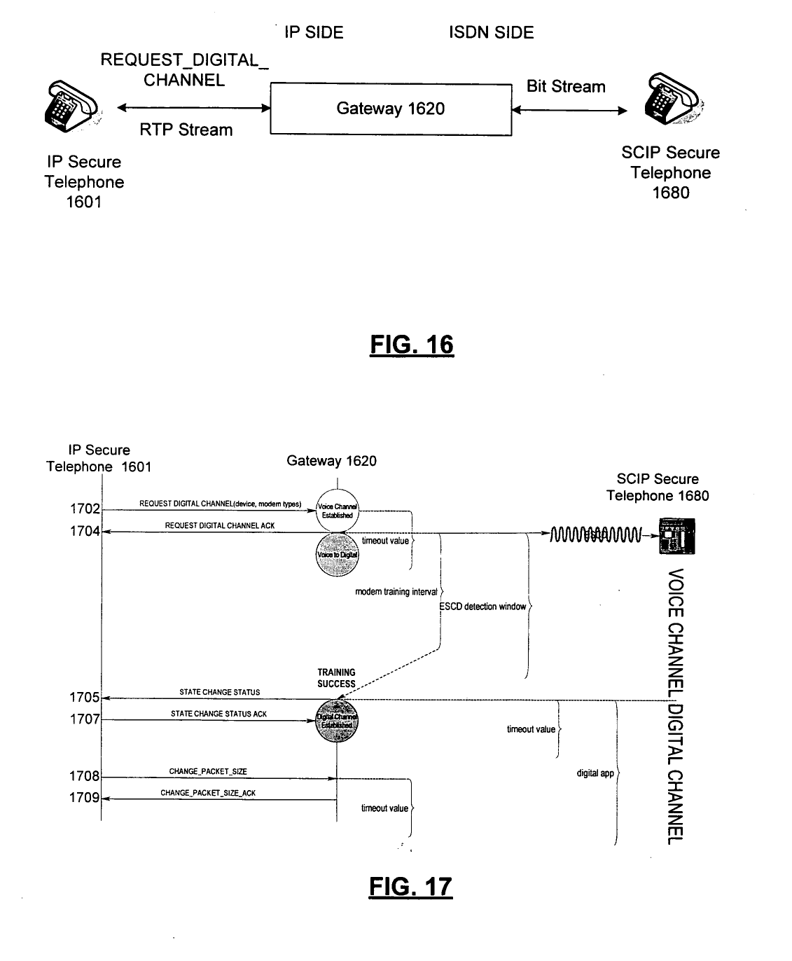

FIG. 16 is a diagram useful in describing an example IP secure telephone 1601 initiating digital channel establishment. FIG. 17 is a diagram showing an example state transition of an example IP secure telephone 1601 initiating digital channel establishment. An IP secure telephone 1601 initiates the establishment a fully digital connection with an SCIP secure telephone 1680 by sending a REQUEST_DIGITAL_CHANNEL message to the gateway 1620 at 1702. The REQUEST_DIGITAL_CHANNEL message allows an IP secure telephone 1601 to identify itself as such to the gateway 1620. The REQUEST_DIGITAL_CHANNEL message also supplies connection parameters to the gateway 1620 to be used during the “modem training” phase of end-to-end digital connection establishment, for example.

Upon receipt of the REQUEST_DIGITAL_CHANNEL message, the gateway desirably initiates modem training with the SCIP secure telephone 1680 by sending the ESCD waveform. The gateway 1680 may confirm receipt of the REQUEST_DIGITAL_CHANNEL message by sending a REQUEST_DIGITAL_CHANNEL_ACK message to the IP secure telephone 1601 at 1704. The gateway 1680 desirably sends a STATE_CHANGE_STATUS message to the IP secure telephone 1601 upon completing modem training with the SCIP secure telephone 1680 at 1705. The STATE_CHANGE_STATUS message allows the gateway to inform the IP secure telephone 1601 that it has successfully completed modem training with an SCIP secure telephone 1680 and that it has changed its operating state to digital channel established.

Status messages include the state change status and the channel status. The state change status goes from the gateway 1620 to the IP secure telephone 1601 and notifies the IP secure telephone 1601 that the gateway has changed its state. 1705 illustrates such a state change message. Events that may trigger the gateway 1620 to send a “State Change Status” message to the IP secure telephone 1601 include: (1) the gateway modem has successfully completed its modem training sequence; (2) the gateway modem has dropped its carrier; and (3) the gateway modem has unexpectedly lost its carrier. Valid states include voice channel established and digital channel established, for example.

Control messages include request digital channel and close digital channel. The request digital channel goes from the IP secure telephone to the gateway, and from the gateway to the IP secure telephone, and has the purpose of obtaining a digital channel of a specified bandwidth. Both the SCIP secure telephone and the IP secure telephone are capable of initiating the establishment of an end-to-end digital connection. The SCIP secure telephone and IP secure telephone use different mechanisms to establish a digital channel.

The gateway confirms receipt of the REQUEST_DIGITAL_CHANNEL message by sending a REQUEST_DIGITAL_CHANNEL_ACK message to the IP secure telephone. The gateway initiates the modem training operation in accordance with the bandwidth and modem parameters specified in the “Acquire Data Channel” message.

What is claimed:

1. A method for secure communication, the method comprising:
establishing a first secure channel over a packet switched network between an internet protocol secure terminal and a gateway;
establishing a second secure channel between the gateway and a secure communication interoperability protocol secure terminal;
receiving data over the first secure channel by the gateway;
transforming the data into data suitable for transmission over the second secure channel by the gateway; and
transmitting the data over the second secure channel by the gateway.

2. The method of claim 1, wherein the data comprises voice data.

3. The method of claim 1, wherein the data comprises digital data.

4. The method of claim 3, wherein digital data is transmitted over the second secure channel by a modem connected to the gateway.

5. The method of claim 1, wherein the data is received over the first channel in an real-time protocol stream.

6. The method of claim 1, wherein the data is transmitted over the second channel in a serial bit stream.

7. The method of claim 1, wherein establishing a first secure channel over a packet switched network between the internet protocol secure terminal and a gateway comprises: receiving a named signaling event request to open the first secure channel by a call manager attached to the gateway, and the call manager establishing the first secure channel responsive to the request.

8. The method of claim 1, wherein establishing the second secure channel between the gateway and the secure communication interoperability protocol secure terminal comprises a modem connected to the gateway conducting modem training with a modem connected to the secure communication interoperability protocol secure terminal.

9. The method of claim 1, wherein the secure communication interoperability protocol secure terminal is an ISDN terminal.

10. The method of claim 1, wherein the secure communication interoperability protocol secure terminal is a public switched telephone network terminal.

11. A gateway for communication between two secure terminals, comprising:
an internet protocol interface for connection to an internet protocol secure terminal;
a secure communication interoperability protocol interface for connection to a secure communication interoperability protocol secure terminal; and
a processor for converting data received through the secure communication interoperability protocol interface into data suitable for the internet secure terminal, and for converting data received through the internet protocol interface into data suitable for the secure communication interoperability protocol secure terminal.

12. The gateway of claim 11, wherein the secure communication interoperability protocol interface comprises a modem for communication with a modem on the secure communication interoperability protocol secure terminal.

13. The gateway of claim 12, wherein the modems synchronize settings through an extended system configuration data waveform.

14. The gateway of claim 11, wherein the connection to the internet protocol secure terminal comprises a bidirectional real-time protocol stream.

15. The gateway of claim 11, wherein the connection to the secure communication interoperability protocol secure terminal comprises a bidirectional bit stream.

16. The gateway of claim 11, wherein the internet protocol interface comprises a call manager for controlling settings between the internet protocol interface and the internet protocol secure terminal.

17. The gateway of claim 16, wherein the internet protocol secure terminal and the call manager communicate using named signaling events.

18. The gateway of claim 11, wherein the secure communication interoperability protocol interface is an ISDN interface.

19. A computer readable medium having stored thereon computer-executable instructions for performing a method comprising:
receiving data over a first secure channel by a gateway from an internet protocol secure telephone;
transforming the data into data suitable for transmission over a second secure channel by the gateway; and
transmitting the data over the second secure channel by the gateway to a secure communication interoperability protocol secure telephone.

20. The computer-readable medium of claim 19, wherein the secure communication interoperability protocol secure telephone is an ISDN telephone.
